(19) United States
(12) Patent Application Publication
(10) Pub. No.: US 2025/0087433 A1
(43) Pub. Date: Mar. 13, 2025

(54) KEY PLUGGING STRUCTURE, KEY ASSEMBLY AND KEYBOARD THEREOF

(71) Applicant: LITE-ON Technology Corporation, Taipei City (TW)

(72) Inventor: Chun-Chieh WU, Taipei City (TW)

(21) Appl. No.: 18/830,623

(22) Filed: Sep. 11, 2024

Related U.S. Application Data
(60) Provisional application No. 63/581,988, filed on Sep. 12, 2023.

(30) Foreign Application Priority Data
Aug. 22, 2024 (CN) 202411157052X

(51) Int. Cl. H01H 13/10

(52) U.S. Cl. CPC H01H 13/10

(57) ABSTRACT

The present invention provides a key plugging structure, a key assembly and a keyboard. The key plugging structure includes a circuit board, a socket member and an elastic member. The circuit board includes a through hole penetrating through the circuit board. The socket member includes a slot and a first jack hole, the first jack hole is formed at the bottom of the slot; the socket member is embedded in the through hole; the first jack hole and the through hole are connected to each other; the elastic member has a second jack hole; the elastic member is assembled in the hole slot; the second socket hole and the first socket hole are connected with each other. Further, the key assembly includes a key. The redesign for the socket of the key plugging structure embedded in the circuit board reduce the height of the key assembly.

### CROSS REFERENCE TO RELATED PRESENT DISCLOSURE

This application claims the priority benefit of Provisional Patent Application Ser. No. 63/581,988, filed on Sep. 12, 2023, and Chinese Patent Application Serial Number 202411157052X, filed on Aug. 22, 2024, the full disclosure of which is incorporated herein by reference.

### TECHNICAL FIELD

The present disclosure relates to the technical field of keys, and in particular to a key plugging structure, a key assembly and a keyboard.

### RELATED ART

Regarding the key structure, there are pins for electrical connection below each key shaft. The circuit board has electrical connection points relative to the pins of the key shaft. The key shaft is electrically connected to the circuit board through pins. An user presses the key to input a signal via the circuit board of the keyboard to the electronic device by the key shaft electrically connecting or disconnecting to the circuit board. In terms of the pluggable key assembly, the circuit board of the keyboard has an electrical mounting base that provides plug-in installation for the key shaft. The key shaft can be directly plugged and assembled without additional welding. If the user needs to replace or repair the key shaft, it can be directly disassembled without using additional tools. However, as mentioned above, the base body of the electrical mounting base which provides the key shaft with installation and fixation has a thickness. Therefore, after the electrical mounting base configured above or below the circuit board, the thickness of the circuit board used for assembling the key shaft increases significantly. When the key shaft is assembled on the electrical mounting base, accordingly the thickness of the entire keyboard also increases significantly, which raised the height of the keyboard.

### SUMMARY

The present application provides a key plugging structure, a key assembly, and a keyboard to solve the problem of the excess height of the key arising from the socket for the key plug-in arranged on the surface of the circuit board by embedding the socket for the key plug-in into the circuit board.

The height of the key affects the key parameters during production such as total volume, total weight, and the amount of raw materials and would increase the production cost. If the amount of raw materials used in the keyboard can be simplified and the height can be reduced, costs can be further reduced. In addition, if the minimum height necessary for key design can be reduced, more different key height combinations would be acquired, so that different user needs can be taken into account when designing keys.

One embodiment of the present application provides a key plugging structure comprising a circuit board, a socket member and an elastic member. The circuit board includes a through hole penetrating through the circuit board. The socket member includes a slot and a first jack hole, the first jack hole is formed at the bottom of the slot; the socket member is embedded in the through hole; the first jack hole and the through hole are connected to each other; the elastic member has a second jack hole; the elastic member is assembled in the hole slot; the second socket hole and the first socket hole are connected with each other.

In one embodiment of the key plugging structure, the through hole further includes an electrical hole and a guide hole; the electrical hole is formed on one side of the guide hole.

In one embodiment of the key plugging structure, the electrical hole includes a socket hole and a positioning hole; the socket hole and the positioning hole are connected with each other; the socket member includes a base portion and a positioning portion; the positioning portion extends outward from one side of the base portion; the base portion is embedded in the socket hole; the positioning portion is embedded in the positioning hole.

In one embodiment of the key plugging structure, the socket member comprises a base portion and a localizing portion; the localizing portion extends outward from the peripheral side of the slot; the localizing portion abuts against the periphery surface of the through hole of the circuit board.

In one embodiment of the key plugging structure, the localizing portion comprises a positioning side corresponding to the side of the guide hole.

In one embodiment of the key plugging structure, the elastic member comprises a body part and two elastic pieces; the two elastic pieces extend separately from two ends of the body part in a direction away from the body part; the adjacent sides of the two elastic pieces are close to each other.

In one embodiment of the key plugging structure, the two elastic pieces are bent, and the adjacent sides of the two elastic pieces are separately bent toward each other with at least one included angle.

In one embodiment of the key plugging structure, the two elastic pieces are bent, and the adjacent sides of the two elastic pieces are separately bent toward each other in an arc shape.

Another embodiment of the present application provides a key assembly having the key plugging structure. The key assembly includes a circuit board, a socket member and an elastic member. The circuit board includes a through hole penetrating through the circuit board. The socket member includes a slot and a first jack hole, the first jack hole is formed at the bottom of the slot; the socket member is embedded in the through hole; the first jack hole and the through hole are connected to each other; the elastic member has a second jack hole; the elastic member is assembled in the slot; the second socket hole and the first socket hole are connected with each other. The key has electrical pins, wherein the electrical pins separately plug into the through hole, the first jack hole and the second jack hole, the elastic member elastically clamping the electrical pins, and the elastic member and the electrical pins being electrically connected to each other.

In one embodiment, the key further comprises a guide post, the through hole of the circuit board comprises an electrical hole and a guide hole, the electrical hole is formed on one side of the guide hole, and the electrical pins of the key assembly insert into the electrical hole, and the guide post of the key assembly inserts into the guide hole.

Another embodiment of the present application provides a keyboard having a plurality of key assemblies.

This application provides a key plugging structure, a key assembly, and a keyboard. The redesigned socket of the present application significantly reduces the thickness of the key while plugging into the circuit board by embedding the socket for key plugging into the circuit board, rather than welding a socket with a certain height on the circuit board as the prior art. In other words, the key plugging structure of the present application may reduce the overall height of the key or keyboard, thus making the mechanical keyboard thinner and lighter.

### BRIEF DESCRIPTION OF THE DRAWINGS

Accompanying drawings described herein are intended to provide a further understanding of the present disclosure and form a part of the present disclosure, and exemplary embodiments of the present disclosure and descriptions thereof are intended to explain the present disclosure but are not intended to unduly limit the present disclosure. In the drawings:

FIG. 1 is a perspective view of the key plugging structure of the present application;

FIG. 2 is another perspective view of the key plugging structure of the present application;

FIG. 3 is an exploded perspective view of the key plugging structure of the present application;

FIG. 4 is another exploded perspective view of the key plugging structure of the present application;

FIG. 5 is a perspective view of the key assembly of the present application;

FIG. 6 is another perspective view of the key assembly of the present application;

FIG. 7 is a cross-sectional view of line A-A′ of FIG. 6;

FIG. 8 is an enlarged view of the first embodiment of the area B of FIG. 7;

FIG. 9 is an enlarged view of the second embodiment of the area B of FIG. 7;

FIG. 10 is an enlarged view of the third embodiment of the area B of FIG. 7; and

FIG. 11 is an enlarged view of the first embodiment of the area B of FIG. 7.

### DETAILED DESCRIPTION OF THE EMBODIMENTS

The embodiments of the present disclosure will be described below in conjunction with the relevant drawings. In the figures, the same reference numbers refer to the same or similar components or method flows.

It must be understood that the words “including”, “comprising” and the like used in this specification are used to indicate the existence of specific technical features, values, method steps, work processes, elements and/or components. However, it does not exclude that more technical features, values, method steps, work processes, elements, components, or any combination of the above can be added.

It must be understood that when an element is described as being “connected” or “coupled” to another element, it may be directly connected or coupled to another element, and intermediate elements therebetween may be present. In contrast, when an element is described as “directly connected” or “directly coupled” to another element, there is no intervening element therebetween.

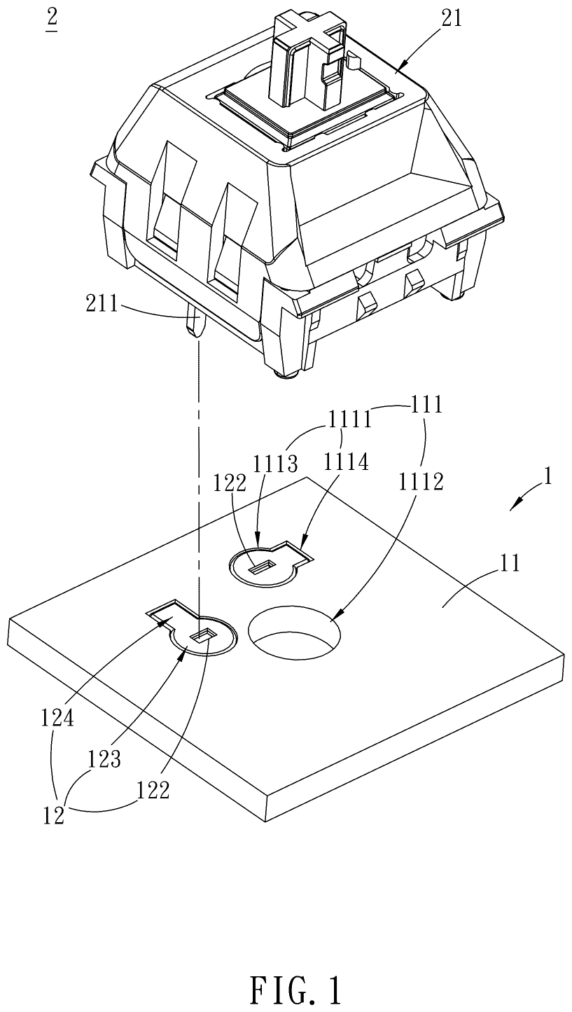

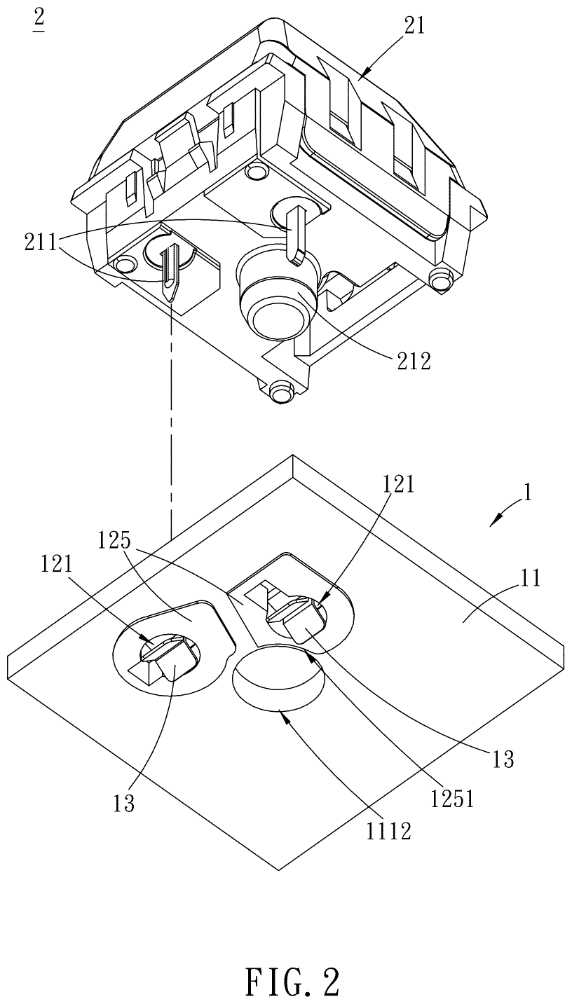

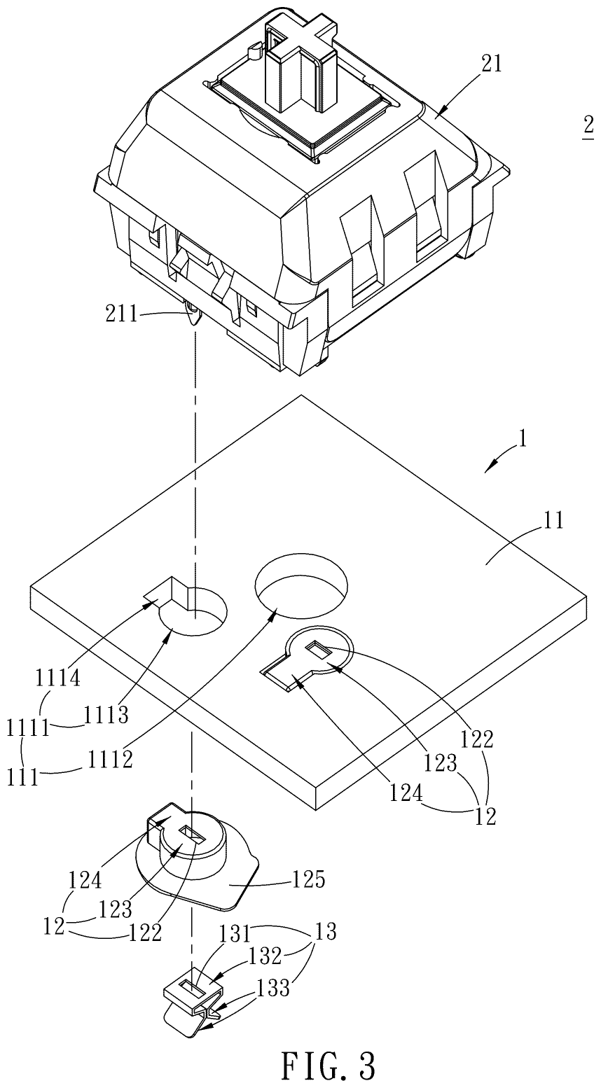

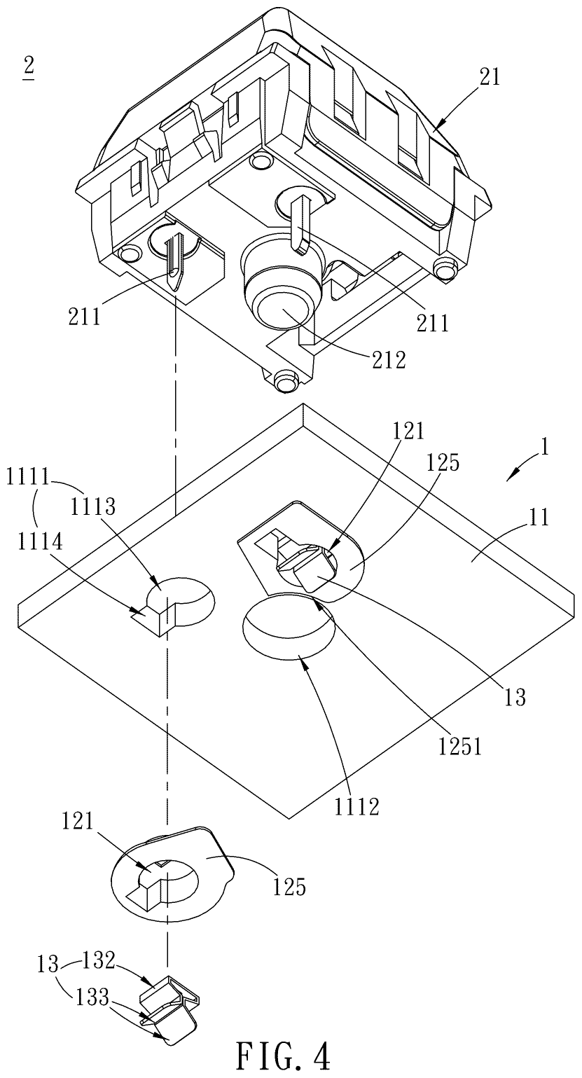

Refer to FIG. 1 to FIG. 4. FIG. 1 is a perspective view of the key plugging structure of the present application; FIG. 2 is another perspective view of the key plugging structure of the present application; FIG. 3 is an exploded perspective view of the key plugging structure of the present application; FIG. 4 is another exploded perspective view of the key plugging structure of the present application. As shown in the figure, the present application provides a key plugging structure 1, which includes a circuit board 11, a socket member 12 and an elastic member 13. The circuit board 11 has a through hole 111 for providing key plug and unplug. The socket member 12 has a slot 121 and a first jack hole 122. The first jack hole 122 is formed at the bottom of the slot 121. The socket member 12 is embedded in the through hole 111. The first jack hole 122 and the through hole 111 are connected with each other. The elastic member 13 has a second jack hole 131. The elastic member 13 is assembled in the slot 121. The second insertion hole 131 and the first insertion hole 122 are connected with each other. The key plugging structure 1 of this embodiment is a combination of a socket 12 and a circuit board 11, which can be formed a single key for electrical plugging. The combination of the socket 12 on the circuit board 11 does not significantly increase the height of the keyboard, and the keys can be plugged in and out for repair or replacement at any time as needed.

In this embodiment, the through hole 111 further include an electrical hole 1111 and a guide hole 1112. The electrical hole 1111 is formed on one side of the guide hole 1112. The electrical hole 1111 and the guide hole 1112 are both for key insertion. The electrical hole 1111 has a socket hole 1113 and a positioning hole 1114. The socket hole 1113 and the positioning hole 1114 are connected with each other. The socket member 12 has a base portion 123 and a positioning portion 124. The positioning portion 124 extends outward from one side of the base portion 123. The base portion 123 is correspondingly embedded in the socket hole 1113. The positioning portion 124 is correspondingly embedded in the positioning hole 1114. The first jack hole 122 is formed in the base portion 123. The outer contour of the socket member 12 of this embodiment corresponds to the hole contour of the electrical hole 1111 in the through hole 111 of the circuit board 11. There are two electrical holes 1111 and a guide hole 1112. The contours of the two electrical holes 1111 can be the same or different. The socket member 12 also has two corresponding to the two electrical holes 1111. In this way, the outer contours of the two socket members 12 can respectively match the hole contours of the two electrical holes 1111. Users can use socket members 12 having different or same structure to match the electrical holes 1111 having different or the same structure according to their needs.

Based on the above, the base portion 123 of the socket member 12 of this embodiment is a cylinder. The socket hole 1113 of the through hole 111 also corresponds to the opening contour of the cylinder. The positioning portion 124 of the socket member 12 is a rectangular body. The positioning hole 1114 of the through hole 111 also corresponds to the opening contour of the rectangular body. The design of matching the positioning hole 1114 of the through hole 111 of the circuit board 11 and the positioning portion 124 of the socket member 12 can effectively avoid the problem of the wrong assembly direction of the socket member 12 when being assembled in the through hole 111.

Furthermore, the socket member 12 also has a localizing portion 125. The localizing portion 125 extends outward from the peripheral side of the slot 121. The localizing portion 125 abuts against the periphery surface the electrical hole 1111 of the through hole 111 of the circuit board 11. When the socket member 12 is embedded in the through hole 111, the depth of the socket member 12 embedded in the through hole 111 is limited by the localizing portion 125, so that the socket member 12 can be just inserted into the electrical hole 1111 of the through hole 111. The localizing portion 125 extends horizontally outward from the peripheral side of the slot 121 of the base portion 123. The localizing portion 125 has a positioning side 1251 corresponding to the side of the guide hole 1112. The circular hole outline of the positioning side 1251 corresponding to the guide hole 1112 appears as an arc shaped. The positioning side 1251 corresponds to the side of the guide hole 1112 adjacent to the positioning side 1251. This can also be used to limit the assembly direction and assembly position of the socket member 12 embedded in the through hole 111.

Refer to FIG. 3 and FIG. 4. The elastic member 13 has a body part 132 and two elastic pieces 133. The two elastic pieces 133 respectively extend from both ends of the body part 132 in a direction away from the body part 132. The adjacent sides of the two elastic pieces 133 are close to each other. The two elastic pieces 133 are bent elastic pieces, and the adjacent sides of the two elastic pieces 133 are bent inwards toward each other. The second jack hole 131 is provided in the body part 132, and the vertical projection of the second jack hole 131 is between the two elastic pieces 133. The elastic member 13 of this embodiment is integrally formed. This embodiment does not limit the structure of the elastic member 13, which can be adjusted according to the user's needs. In addition, the elastic member 13 of this embodiment is made of metal and has elastic recovery properties. When the elastic pieces 133 of the elastic member 13 are separated outwardly by an external force, the elastic restoring force of the elastic member 13 provides an inward clamping force.

Based on the above, the elastic member 13 is assembled in the slot 121 of the socket member 12. The inner contour of the slot 121 of the socket member 12 also corresponds to the outer contour shape of the base portion 123 and the positioning portion 124. The elastic member 13 is assembled in the slot 121 corresponding to the position of the base portion 123. The elastic member 13 and the socket member 12 are made of metal. The elastic member 13 is fixed to the socket member 12 by wave soldering or reflow soldering. Alternatively, the elastic member 13 and the socket member 12 can also be assembled and fastened through an auxiliary structure, so that the elastic member 13 is fixed in the slot 121 of the socket member 12.

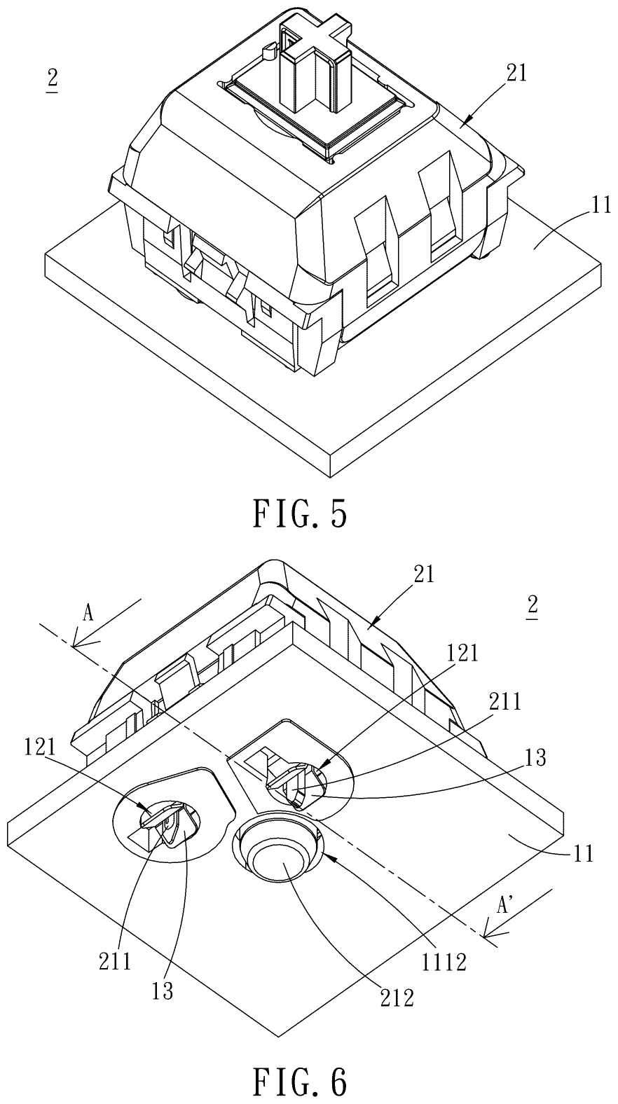

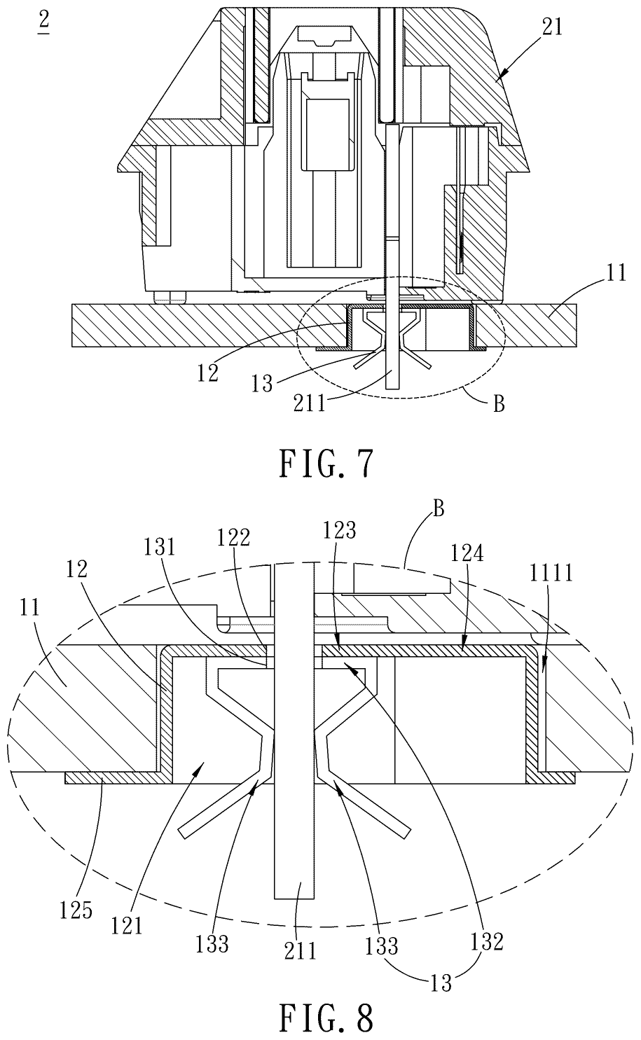

Refer to FIG. 5 to FIG. 8. FIG. 5 is a perspective view of the key assembly of the present application; FIG. 6 is another perspective view of the key assembly of the present application; FIG. 7 is a cross-sectional view of line A-A′ of FIG. 6; FIG. 8 is an enlarged view of the first embodiment of the area B of FIG. 7. As shown in the figure, this embodiment provides a key assembly 2 with a key plugging structure 1. The key 21 inserts into the key plugging structure 1. In this embodiment, the key 21 has two electrical pins 211 and a guide post 212. The guide post 212 is disposed at the center of the key 21. The two electrical pins 211 are disposed on one side of the guide post 212. The electrical pin 211 inserts into the electrical hole 1111 of the through hole 111 so that the electrical pin 211 inserts into the socket member 12 and the elastic member 13. One end of the electrical pin 211 inserts through the first jack hole 122 of the socket member 12 and the second jack hole 131 of the elastic member 13 in sequence. When the electrical pin 211 passes between the two elastic pieces 133, the electrical pin 211 pushes the two elastic pieces 133 outward, and the elastic restoring force of the two elastic pieces 133 of the elastic member 13 acts inward, so that the two elastic pieces 133 elastically fix the electrical pins 211. In other words, the electrical pin 211 is clamped and fixed by the two elastic pieces 133. At the same time, the electrical pins 211 and the two elastic pieces 133 of the elastic member 13 can be electrically connected to each other because they are both made of conductive materials. In addition, the guide post 212 inserts into the guide hole 1112 of the through hole 111, so that the auxiliary key 21 is installed at the center of the key plugging structure 1.

Refer to FIG. 8. The two elastic pieces 133 of the elastic member 13 in this embodiment are bent elastic pieces. The adjacent sides of the two elastic pieces 133 are bent toward each other with multiple included angles. The single elastic piece 133 in FIG. 8 is bent at least twice, and the elastic piece 133 has at least two included angles, so that the contact surface of the electrical pin 211 with respect to the two elastic pieces 133 is a flat surface. In addition, this embodiment does not limit the number of times to bend the elastic piece 133. After the single elastic piece 133 is bent at least once, the bending part of the elastic piece 133 may contact the electrical pin 211. The number of bends can be adjusted according to the user's needs.

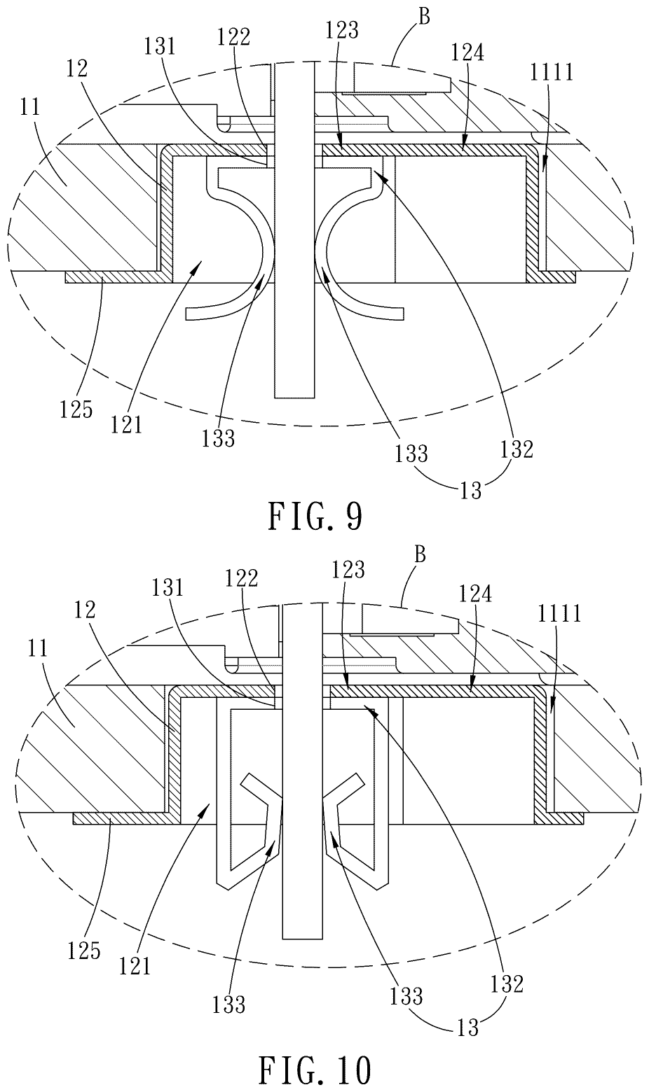

Refer to FIG. 9. FIG. 9 is an enlarged view of the second embodiment of the area B of FIG. 7. As shown in the figure, the difference between the elastic member 13 of this embodiment and the elastic member of FIG. 8 lies in the bending method. The two elastic pieces 133 of the elastic member 13 in this embodiment are bent elastic pieces. The adjacent sides of the two elastic pieces 133 are bent towards each other in an arc shape, so that the contact surface of the electrical pin 211 with respect to the two elastic pieces 133 is an arc surface.

Refer to FIG. 10. FIG. 10 is an enlarged view of the third embodiment of the area B of FIG. 7. As shown in the figure, the difference between the elastic member 13 of this embodiment and the elastic member of FIG. 8 lies in the bending method. The two elastic pieces 133 are bent elastic pieces in a barb shape. After one end of the two elastic pieces 133 are bent toward each other, one ends of the two elastic pieces 133 are bent and extended toward the body part 132 and away from each other from the position of the vertical projection of the second jack hole 131. When the electrical pin 211 inserts into the two elastic pieces 133, the electrical pin 211 first passes through one end of the two elastic pieces 133 that are far away from each other, and then contact the adjacent parts of the two elastic pieces 133. When one end of the electrical pin 211 moves and inserts into the elastic member 13, and the insertion direction of one end of the electrical pin 211 is slightly offset, one end of the two elastic pieces 133 that are far away from each other can accommodate one end of the electrical pin 211 with a deviation in the insertion direction. When one end of the electrical pin 211 moves and touches either end of the two elastic pieces 133 that are far away from each other, one end of the electrical pin 211 moves along the inner surface of the elastic piece 133. In this way, the electrical pin 211 is guided to move toward the adjacent place of the two elastic pieces 133, and then the electrical pin 211 is clamped and contacted by the adjacent place of the two elastic pieces 133. This application does not limit the structure of the elastic member 13, and a suitable structure can be selected for the elastic member 13 according to the user's needs.

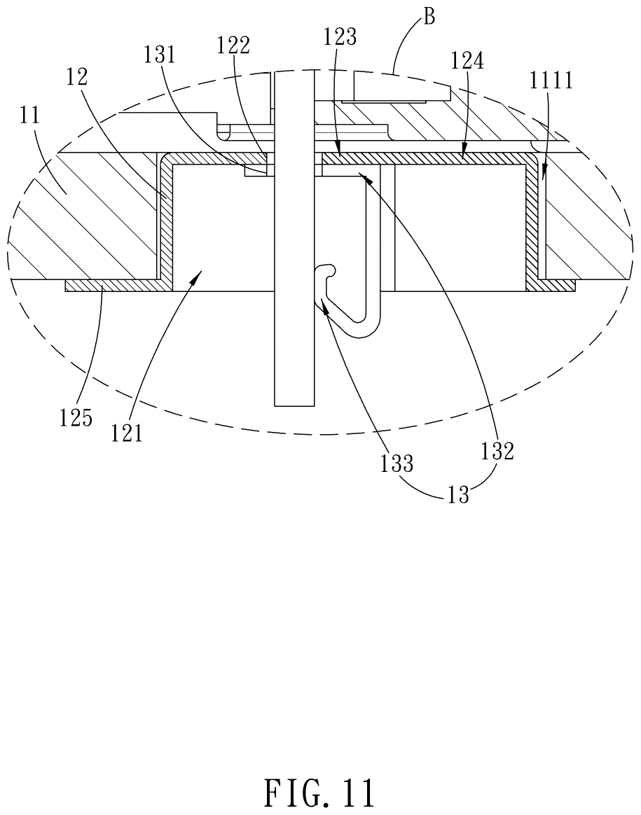

Refer to FIG. 11. FIG. 11 is an enlarged view of the first embodiment of the area B of FIG. 7. As shown in the figure, the difference between the elastic member 13 of this embodiment and the elastic member of FIG. 10 lies in the bending method and the number of bends. The elastic member 13 of this embodiment has a body part 132 and an elastic piece 133. The elastic piece 133 extends from one end of the body part 132 in a direction away from the body part 132. One side of the elastic piece 133 is close to the position of the vertical projection of the second jack hole 131. The elastic piece 133 is a bending elastic piece, and the elastic piece 133 is bent inwards and approaches. The elastic piece 133 is a bent elastic piece in a barb shape. After one end of the elastic piece 133 is bent, one end of the elastic piece 133 is bent and extended toward the body part 132 and away from the position of the vertical projection of the second jack hole 131. The bend of the elastic piece 133 is close to the position of the vertical projection of the second jack hole 131. The effect of having one end of the elastic piece 133 away from the position of the vertical projection of the second jack hole 131 is as described as guiding the insertion direction of the electrical pin 211 in the previous paragraphs and therefore will not be described again.

This embodiment further provides a keyboard, which includes a plurality of key assemblies 2 having key plugging structures 1. This embodiment can apply a plurality of key assemblies 2 with key plugging structures 1 to various mechanical keyboards, which can improve the shortcoming of the excess thickness and weight of the mechanical keyboard.

To sum up, this application provides a key plugging structure, a key assembly and a keyboard. Compared with the prior art, which is to weld a socket with a certain height on one side of the circuit board, the socket of the present application significantly reduces the height of the key when it is plugged into the circuit board by way of fitting the socket for key plugging into the circuit board. In other words, the key plugging structure of the present application may reduce the overall height of the key or keyboard, thus making the mechanical keyboard thinner and lighter.

While the present disclosure is disclosed in the foregoing embodiments, it should be noted that these descriptions are not intended to limit the present disclosure. On the contrary, the present disclosure covers modifications and equivalent arrangements obvious to those skilled in the art. Therefore, the scope of the claims must be interpreted in the broadest manner to comprise all obvious modifications and equivalent arrangements.

What is claimed is:

1. A key plugging structure, comprising:
a circuit board having a through hole, the through hole penetrating through the circuit board;
a socket member having a slot and a first jack hole, the first jack hole being formed at the bottom of the slot, the socket member embedded in the through hole, the first jack hole and the through hole being connected with each other; and
an elastic member having a second jack hole, the elastic member being assembled in the slot, the second jack hole and the first jack hole being connected with each other.

2. The key plugging structure according to claim 1, wherein the through hole further comprises an electrical hole and a guide hole; the electrical hole is formed on one side of the guide hole.

3. The key plugging structure according to claim 2, wherein the electrical hole comprises a socket hole and a positioning hole; the socket hole and the positioning hole are connected with each other; the socket member comprises a base portion and a positioning portion; the positioning portion extends outward from one side of the base portion; the base portion is embedded in the socket hole; the positioning portion is embedded in the positioning hole.

4. The key plugging structure according to claim 2, wherein the socket member comprises a base portion and a localizing portion; the localizing portion extends outward from the peripheral side of the slot; the localizing portion abuts against the periphery surface of the through hole of the circuit board.

5. The key plugging structure according to claim 4, wherein the localizing portion comprises a positioning side corresponding to the side of the guide hole.

6. The key plugging structure according to claim 1, wherein the elastic member comprises a body part and two elastic pieces; the two elastic pieces extend separately from two ends of the body part in a direction away from the body part; the adjacent sides of the two elastic pieces are close to each other.

7. The key plugging structure according to claim 6, wherein the two elastic pieces are bent, and the adjacent sides of the two elastic pieces are separately bent toward each other with at least one included angle.

8. The key plugging structure according to claim 6, wherein the two elastic pieces are bent, and the adjacent sides of the two elastic pieces are separately bent toward each other in an arc shape.

9. The key plugging structure according to claim 7, wherein the second jack hole is provided on the body part, and the vertical projection of the second jack hole is between the two elastic pieces.

10. The key plugging structure according to claim 8, wherein the second jack hole is provided on the body part, and the vertical projection of the second jack hole is between the two elastic pieces.

11. The key plugging structure according to claim 9, wherein the second jack hole is provided on the body part, and the vertical projection of the second jack hole is between the two elastic pieces.

12. A key assembly comprising:
a circuit board having a through hole, the through hole penetrating through the circuit board;
a socket member having a slot and a first jack hole, the first jack hole being formed at the bottom of the slot, the socket member embedded in the through hole, the first jack hole and the through hole being connected with each other;
an elastic member having a second jack hole, the elastic member being assembled in the slot, the second jack hole and the first jack hole being connected with each other; and
a key having electrical pins, wherein the electrical pins separately plug into the through hole, the first jack hole and the second jack hole, the elastic member elastically clamping the electrical pins, and the elastic member and the electrical pins being electrically connected to each other.

13. The key assembly according to claim 12, wherein the key assembly further comprises a guide post, the through hole of the circuit board comprises an electrical hole and a guide hole, the electrical hole is formed on one side of the guide hole, and the electrical pins of the key assembly insert into the electrical hole, and the guide post of the key assembly inserts into the guide hole.

14. A keyboard comprises a plurality of the key assemblies according to claim 12.

15. A keyboard comprises a plurality of the key assemblies according to claim 13.
